(19) United States
(12) Patent Application Publication
(10) Pub. No.: US 2024/0423141 A1
(43) Pub. Date: Dec. 26, 2024

(54) BACKPACK BLOWER WITH MIXED FLOW FAN

(71) Applicant: Greenworks (Jiangsu) Co., Ltd, Changzhou (CN)

(72) Inventor: Nicholas Suchoza, Mooresville, NC (US)

(21) Appl. No.: 18/749,784

(22) Filed: Jun. 21, 2024

Related U.S. Application Data
(60) Provisional application No. 63/522,519, filed on Jun. 22, 2023.

(51) Int. Cl. A01G 20/47

(52) U.S. Cl. CPC A01G 20/47

(57) ABSTRACT

This disclosure provides a backpack blower with mixed flow fan. The backpack blower includes a frame assembly, a fan connected to the frame assembly and a discharge tube assembly connected to the fan. The frame assembly used to support an electric power pack for storing and discharging electric energy. The fan includes a fan housing provided with a protruding portion and extending from an inlet end and an outlet end, and an impeller housed in the fan housing. The blade of the impeller is configured to guide airflow to have both a radial velocity component and an axial velocity component.

### CROSS REFERENCE TO RELATED APPLICATIONS

The present application claims the benefit of U.S. Provisional Patent Application No. 63/522,519 filed on Jun. 22, 2023, the contents of which are incorporated herein by reference in their entirety.

### BACKGROUND OF THE INVENTION

This invention relates generally to outdoor power equipment, and more particularly to blowers.

### BACKGROUND

Various types of outdoor power blowers are known. They may be driven by internal combustion engines, mains electric power, or by battery packs.

Some blowers use a centrifugal type fan which provides good air power but lacks efficiency and can be difficult to package. Others use an axial type fan which is more compact and has higher efficiency, but may not be as powerful.

There remains a need for an electric-powered blower having good efficiency in a compact design.

### BRIEF SUMMARY OF THE INVENTION

This need is addressed by a backpack blower including a mixed flow fan.

### BRIEF DESCRIPTION OF THE DRAWINGS

The invention may be best understood by reference to the following description taken in conjunction with the accompanying drawing figures in which:

FIG. 1 is a rear perspective view of a first exemplary embodiment of a backpack blower;

FIG. 2 is a front perspective view of the blower of FIG. 1;

FIG. 3 is a side perspective view of the blower of FIG. 1;

FIG. 4 is a rear perspective view of the blower of FIG. 1, with a cover removed showing the internal components;

FIG. 5 is a front perspective view of a frame assembly of the blower of FIG. 1;

FIG. 6 is a rear perspective view of the frame assembly of FIG. 5;

FIG. 7 is a rear perspective view of a second exemplary embodiment of a backpack blower; and

FIG. 8 is a front perspective view of the blower of FIG. 6.

### DETAILED DESCRIPTION OF THE INVENTION

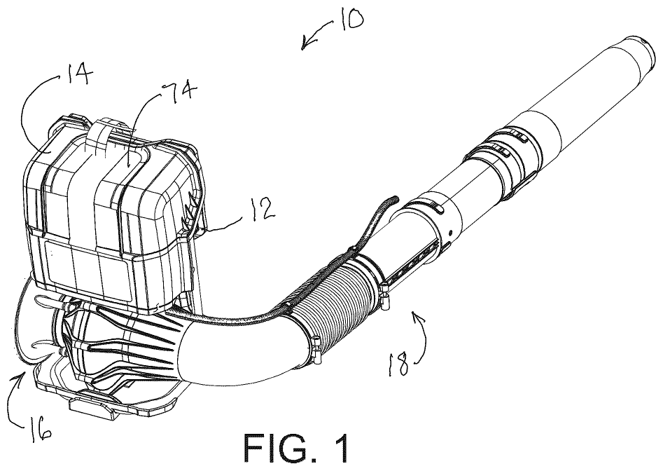

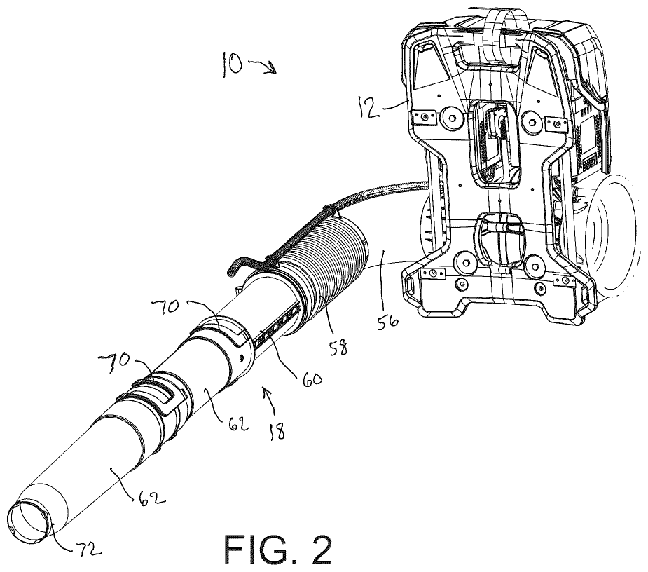

Referring to the drawings wherein identical reference numerals denote the same elements throughout the various views, FIGS. 1-4 show a representative embodiment of a blower 10.

The blower 10 has a frame assembly 12 which provides structural support as well as mounting locations for the various components of the blower 10. Any material with adequate structural strength may be used to construct the frame assembly 12, such as metals or plastics. The frame assembly 12 may be monolithic or may be built up from smaller components, e.g., via fasteners, adhesives, or welding.

The frame assembly 12 supports an electric power pack 14, a fan 16, and a discharge tube assembly 18. Each of these components will be described in detail.

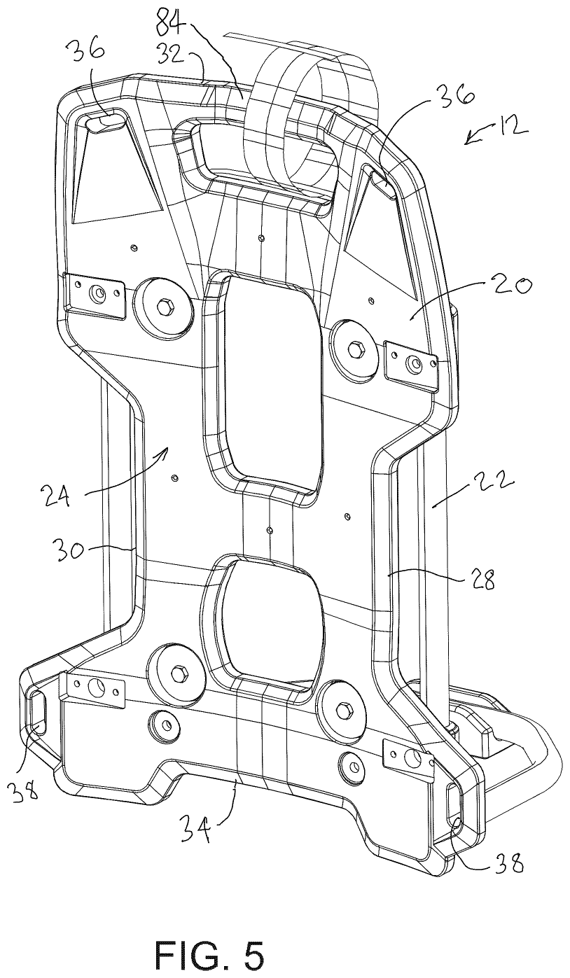

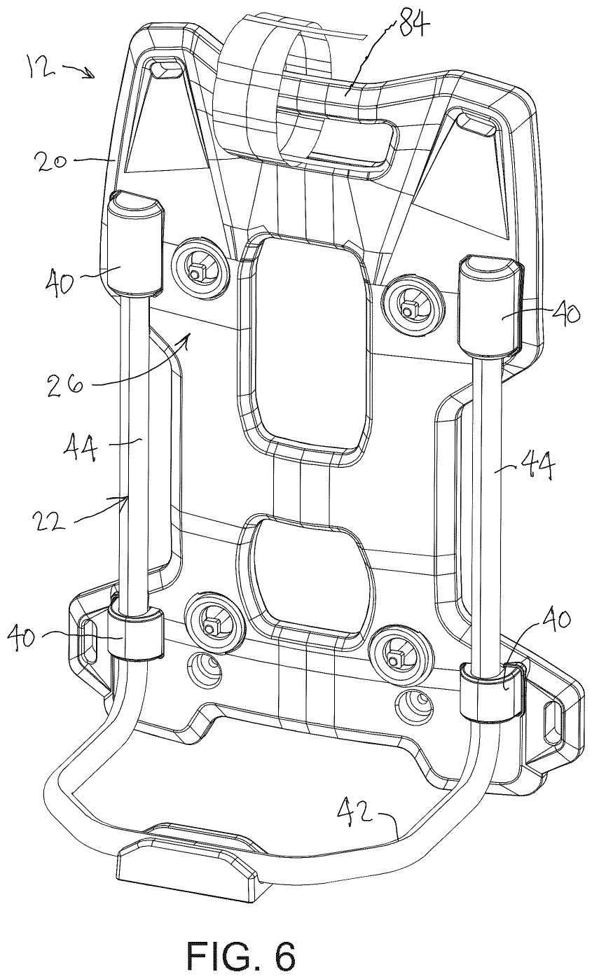

The frame assembly 12, best seen in FIGS. 5 and 6, includes a back plate 20 and an optional reinforcing frame 22. The back plate 20 may be made from a strong lightweight material such as plastic or plastic composite. It has a front face 24 and an opposed back face 26, and extends between left and right edges 28, 30 respectively, and top and bottom edges 32, 34, respectively. The upper portion of the back plate 20 includes left and right upper strap mounting points 36 for securing flexible shoulder straps (not shown). The lower portion of the back plate 20 includes left and right lower strap mounting points 38 for securing a belt (not shown) and/or the lower portion of shoulder straps. In the illustrated example, a carrying handle 84 is formed in the upper portion of the back plate 20. The back plate 20 includes other mounting points as required to secure and connect needed components. The back plate 20 may be formed in an ergonomic shape. For example, at least the front face 24 of the back plate 20 in this example is concave to better conform to the human body.

If used, the optional reinforcing frame 22 would serve to provide structural stiffness to the back plate 20 and act as a stand and protective bumper for the blower 10. In the illustrated example, it is formed of metal tubing and secured to the back plate 20 with brackets 40 and suitable fasteners. It includes a generally C-shaped section 42 extending aft from the back face 26 of the back plate 20. A pair of uprights 44 extend parallel to the back face 26 of the back plate 20.

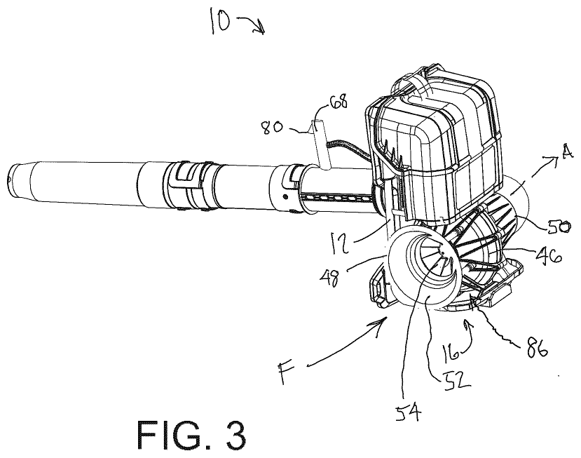

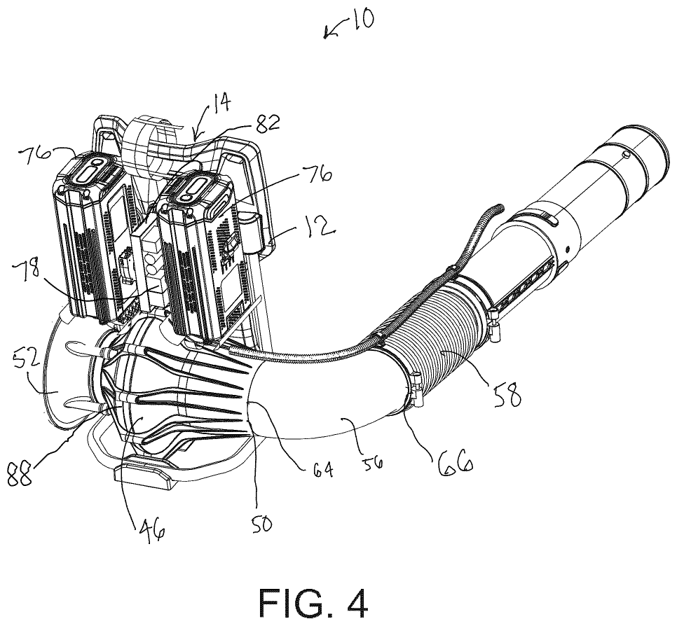

The fan 16 has a fan housing 46 which is generally a body of revolution and extends from an inlet end 48 to an outlet end 50. An air intake 52 is disposed at the inlet end 48 and has a shape which may be straight or which may converge in flow area in the direction of flow (labeled “F”). The air intake 52 may be smoothly curved to guide airflow into the fan 16. The fan housing 46 comprises a protruding portion 88 and has a shape in which the inner diameter at the protruding portion 88 is larger than the inner diameter at the inlet end 48 and the outlet end 50 (visible in FIG. 4). The fan housing 46 encloses an impeller 54 (partially visible in FIG. 3) that is mounted for rotation within the fan housing 46. It rotates about an axis marked “A”. Inside the fan housing 46, the impeller 54 is mechanically coupled to an electric motor (not visible in the drawings). Input of electrical power to the electric motor causes the impeller 54 to rotate, drawing air from the air intake 52 and discharging it through the outlet end 50 of the fan housing 46.

The fan 16 is of a “mixed-flow” type, meaning that the blade of the impeller 54 is configured such that airflow within the fan 16 has both a radial velocity component (perpendicular to axis A) and an axial velocity component (parallel to axis A). In one example, airflow enters the air intake 52 in an axial direction, flows radially outboard as energy is added by the impeller 54, turns radially inward as it diffuses, increasing its pressure, and finally turns in an axial direction prior to exiting the outlet end 50. The fan 16 thus incorporates beneficial aspects of conventional centrifugal-flow blowers while maintaining a compact size and beneficial flow discharge direction of an axial blower.

The discharge tube assembly 18 includes, in flow sequence, an elbow 56, a flex tube 58, a discharge tube 60, and one or more extension tubes 62.

The elbow 56 has a first end 64 connected to the outlet end 50 of the fan housing 46 and a second end 66 connected to the flex tube 58. The elbow 56 is configured to turn airflow passing therethrough through an angle of approximately 90 degrees. The elbow 56 may be fixed, or it may be coupled to the fan housing 46 in such a way that it can rotate about the axis “A”, effectively elevating or depressing the discharge tube assembly 18.

The flex tube 58 is configured so as to permit the discharge tube assembly 18 to flex to a limited degree in one or more axes e.g. left-right or up-down. This function may be accomplished by making the flex tube 58 from corrugated or convoluted pipe, such as a plastic, rubber, or elastomeric material.

The discharge tube 60 extends downstream from the flex tube 58. It may serve as a mounting point for a handgrip 68.

One or more extension tubes 62 may be coupled to the discharge tube 60 to provide for greater overall length, to permit breakdown of the assembly for shipping or storage, and/or to provide adjustability of length. In the illustrated example, a first extension tube 62 is coupled to the discharge tube 60 with a twist-lock connection 70, and a second extension tube 62 is coupled to the first extension tube 62, also with a twist-lock connection 70. The second extension tube 62 terminates at its distal end with an optional nozzle 72 which functions to increase airflow velocity exiting the extension tube 62.

The electric power pack 14 is suitable for storing and discharging electric energy. The electric power pack 14 is protected by an optional external cover 74. In the illustrated example, the electric power pack 14 incorporates one or more removable battery packs 76. Each battery pack 76 is a storage battery including one or more chemical cells, for example, lithium ion cells. Other liquid battery chemistries may be substituted, as well as solid state batteries, capacitors, or similar devices which may exist currently or be later developed. The electric power pack 14 may include ancillary electric components such as inverters, transformers, voltage converters, relays, circuit breakers, and/or sensors. In the illustrated example, each battery pack 76 may be rated at a voltage such as such as 24V, 40V, 60V, or 80V (nonlimiting examples) and have an amp-hour capacity suitable to provide a reasonable runtime for the blower 10. Optionally, each battery pack 76 may have an additional set of terminals providing a low voltage output (e.g. 12V) for operating the control systems of the blower 10.

The blower 10 is equipped with suitable electric connections, controls, and switching equipment to permit the operator to control the functions of the blower 10. In the illustrated example, see FIG. 4, the blower 10 includes a motor controller 78. The motor controller 78 includes an electric power connection to the electric power pack 14 as well as connections to operator controls as described below. The motor controller 78 is operable to receive a command signal from an operator control and to provide electric power to drive the fan 16 at the commanded speed.

The blower 10 carries one or more operator controls within reach of the operator. The primary operator controls include a handgrip 68 mounted to the discharge tube 60. The handgrip 68 includes a primary operator control in the form of a variable-speed trigger 80.

Further controls are not separately illustrated but can include one or more of the following: a key switch or other security device; a main power switch; an emergency stop control; and/or a fan speed control. These further controls may be mounted, for example, on the hand grip 68.

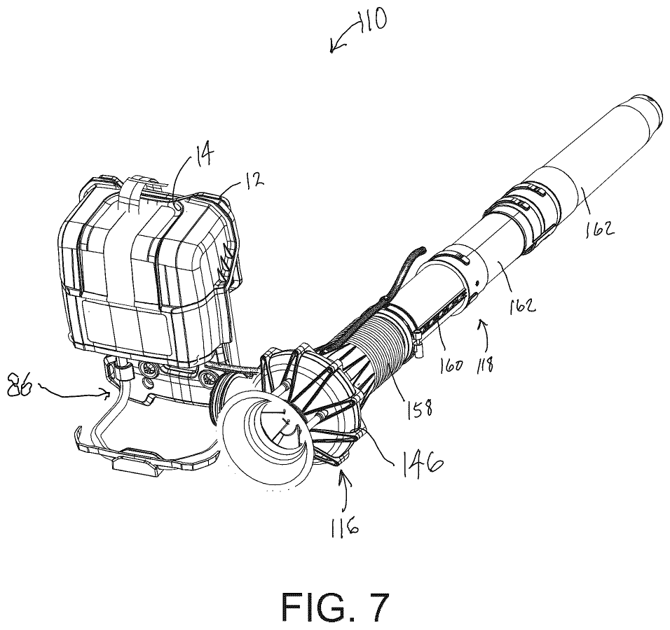

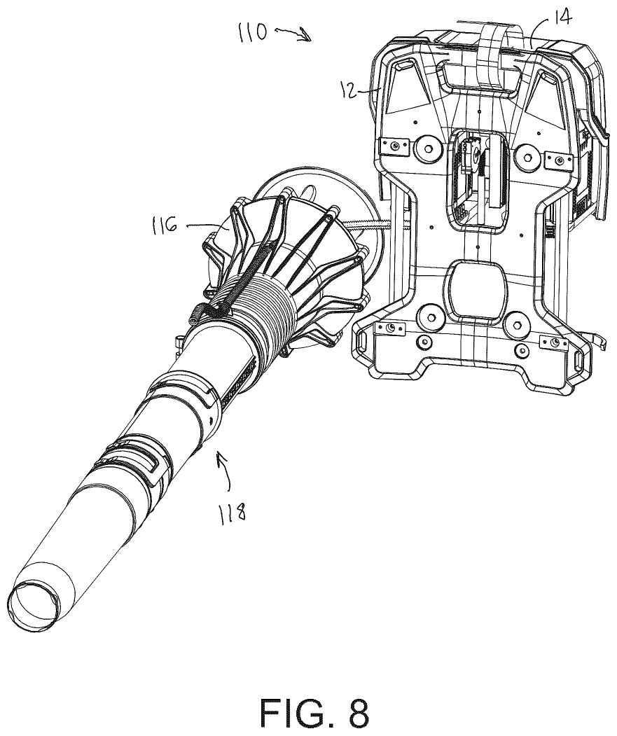

FIGS. 7 and 8 illustrate an alternative embodiment of a backpack blower, label 110 generally. The backpack blower 110 is similar in construction to the backpack blower 10 described above. Elements of the backpack blower 110 not specifically described may be taken to be identical to the corresponding elements of the backpack blower 10.

The backpack blower 110 includes a frame assembly 12, an electric power pack 14, a fan 116, and a discharge tube assembly 118. The fan 116 is substantially similar to the fan 16 except that it is mounted laterally adjacent to the frame assembly 12. It is axially aligned with the discharge tube assembly 118 and lacks the elbow of the blower 10 described above. The discharge tube assembly 118 includes a flex tube 158 mounted directly to a fan housing 146, discharge tube 160, and one or more extension tubes 162. Operation of the blower 110 is substantially as described for the blower 10 described above.

The blower described herein has advantages over prior art machines. It enables efficient high-power blower operation in a compact package. One specific packaging advantage relates to the placement of the fan 16 relative to the electric power pack 14. As best seen in FIG. 4, from a rear view, the frame assembly 12 is provided with a receiving groove 86, and the fan 16 is mounted in the receiving groove 86, and the inlet end 48 and the outlet end 50 of the fan housing 46 are respectively located on both sides of the frame assembly 12. Lower portions of the battery packs 76 and related coupling equipment (e.g., terminal and battery ejection system) flank the sides of a protruding portion 88 of the fan housing 46, enabling them to sit below the “peak” of this protruding portion of the fan housing 46 for a more compact layout.

Preferably, the electric power pack comprises two removable battery packs 76, the frame assembly 12 is provided with an installation portion 82 configured to support the two removable battery packs 76 which is above the fan housing 46, the two removable battery packs 76 are disposed at two sides of the protruding portion 88 of the fan housing 46. An accommodation space is formed between the two removable battery packs 76, and the protruding portion 88 of the fan housing 46 is at least partially arranged in the accommodation space.

The foregoing has described a backpack blower. All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends, or to any novel one, or any novel combination, of the steps of any method or process so disclosed.

What is claimed is:

1. A backpack blower, comprising:
a frame assembly, configured to support an electric power pack for storing and discharging electric energy,
a fan connected to the frame assembly and a discharge tube assembly connected to the fan, wherein
the fan comprises a fan housing and an impeller housed in the fan housing, and
the blade of the impeller is configured to guide airflow to have both a radial velocity component and an axial velocity component.

2. The backpack blower according to claim 1, wherein,
the fan housing has a body of revolution and extends from an inlet end to an outlet end.

3. The backpack blower according to claim 2, wherein,
an air intake is disposed at the inlet end and has a shape with a straight or converging flow area in the direction of flow.

4. The backpack blower according to claim 1, wherein,
the fan housing comprises a protruding portion and has a shape in which the inner diameter at the protruding portion is larger than the inner diameter at the inlet end and the outlet end.

5. The backpack blower according to claim 2, wherein,
the frame assembly is provided with a receiving groove, and the fan is mounted in the receiving groove.

6. The backpack blower according to claim 5, wherein,
the inlet end and the outlet end of the fan housing are respectively located on both sides of the frame assembly.

7. The backpack blower according to claim 4, wherein,
the electric power pack comprises two removable battery packs, the frame assembly is provided with an installation portion configured to support the two removable battery packs which is above the fan housing, the two removable battery packs are disposed at two sides of the protruding portion of the fan housing.

8. The backpack blower according to claim 7, wherein,
an accommodation space is formed between the two removable battery packs, and the protruding portion of the fan housing is at least partially arranged in the accommodation space.

9. The backpack blower according to claim 1, wherein,
the discharge tube assembly comprises, in flow sequence, an elbow connected to the fan, a flex tube connected to the elbow, and a discharge tube connected to the flex tube.

10. The backpack blower according to claim 9, wherein,
the elbow has a first end connected to the outlet end of the fan housing and a second end connected to the flex tube, configured to turn airflow passing therethrough through an angle of approximately 90 degrees.

11. The backpack blower according to claim 9, wherein,
the discharge tube assembly further comprises one or more extension tubes coupled to the discharge tube to provide a greater overall length.

12. The backpack blower according to claim 9, wherein,
the discharge tube assembly extends downstream from the flex tube, and serves as a mounting point for a handgrip.

13. The backpack blower according to claim 1, wherein,
the frame assembly comprises a back plate having a front face and an opposed back face and a reinforcing frame secured to the back plate.

14. The backpack blower according to claim 13, wherein, the upper portion of the back plate comprises left upper mounting point and right upper strap mounting point, the lower portion of the back plate comprises left lower mounting point and right lower strap mounting point.

15. The backpack blower according to claim 14, wherein,
the upper portion of the back plate is provided with a carrying handle.

16. The backpack blower according to claim 13, wherein,
the reinforcing frame comprises a generally C-shaped section extending aft from the back face of the back plate and a pair of uprights extending parallel to the back face of the back plate.

17. The backpack blower according to claim 1, wherein,
the backpack blower further comprises an external cover for housing the electric power pack.

18. The backpack blower according to claim 1, wherein,
the fan mounted laterally adjacent to the frame assembly, and a discharge tube assembly connected to the fan.

19. The backpack blower according to claim 18, wherein,
the discharge tube assembly comprises, in flow sequence, a flex tube connected directly to the fan housing, a discharge tube and one or more extension tubes.

20. The backpack blower according to claim 19, wherein,
one end of the flex tube is connected to the outlet end of the fan housing and the other end of the flex tube is connected to the discharge tube.
